(19) United States
(12) Patent Application Publication
(10) Pub. No.: US 2022/0046121 A1
(43) Pub. Date: Feb. 10, 2022

(54) MOBILE TERMINAL

(71) Applicant: VIVO MOBILE COMMUNICATION CO.,LTD., Guangdong (CN)

(72) Inventors: Biquan Mai, Guangdong (CN); Junhui Chen, Guangdong (CN)

(21) Appl. No.: 17/506,961

(22) Filed: Oct. 21, 2021

Related U.S. Application Data
(63) Continuation of application No. PCT/CN2020/082083, filed on Mar. 30, 2020.

(30) Foreign Application Priority Data
Apr. 24, 2019 (CN) 201910334752.4

(51) Int. Cl. H04M 1/03; H04R 9/06; H04M 1/02

(52) U.S. Cl. CPC H04M 1/035; H04R 2400/11; H04M 1/026; H04R 9/06

(57) ABSTRACT

A mobile terminal is provided. The mobile terminal includes: a receiver, disposed on one side of a center line of the mobile terminal, where a sound outlet hole is provided in a display screen of the mobile terminal, a front cavity sound outlet channel of the receiver is provided inside the mobile terminal, and the front cavity sound outlet channel communicates with the sound outlet hole; and a through-hole is provided at the top of the mobile terminal, and the through-hole communicates with the front cavity sound outlet channel.

### CROSS-REFERENCE TO RELATED APPLICATIONS

This application is continuation application of PCT International Application No. PCT/CN2020/082083 filed on Mar. 30, 2020, which claims priority to Chinese Patent Application No. 201910334752.4, filed in China on, Apr. 24, 2019, the disclosures of which are incorporated herein by reference in their entireties.

### TECHNICAL FIELD

The present disclosure relates to the field of communications technologies, and in particular, to a mobile terminal.

### BACKGROUND

A receiver of a mobile terminal is disposed inside the mobile terminal, and specifically at a position of the mobile terminal close to the top. As the receiver of the mobile terminal is not arranged in the middle of the mobile terminal, the receiver is leftward or rightward from the middle (that is, the receiver is closer to a left side of the mobile terminal, or the receiver is closer to a right side of the mobile terminal). As such, because a narrow slit for sounds to reach out is located in the top middle of a display screen of the mobile terminal, a sound outlet channel that communicates between the receiver and the narrow slit on the display screen is also leftward or rightward from the middle.

The receiver being arranged leftward from the middle is used as an example. When a user uses a mobile terminal with a receiver arranged leftward to receive a speech, if the user listens with the left ear, a part of the left ear in contact with the mobile terminal may block a first part of the narrow slit (the first part is a part of the narrow slit close to the sound outlet channel), such that a sound made by the receiver may be transmitted out only through a second part of the narrow slit (the second part is a part of the narrow slit far from the sound outlet channel).

Because a distance between the receiver and the second part of the narrow slit is relatively farther, a sound transmitted out through the second part of the narrow slit is low in volume and poor in tone quality, which will affect a speech receiving quality of the mobile terminal.

### SUMMARY

Embodiments of the present disclosure provide a mobile terminal.

An embodiment provides a mobile terminal, where the mobile terminal includes:

a receiver, disposed on one side of a center line of the mobile terminal, where

a sound outlet hole is provided in a display screen of the mobile terminal, a front cavity sound outlet channel of the receiver is provided inside the mobile terminal, and the front cavity sound outlet channel communicates with the sound outlet hole; and

a through-hole is provided at the top of the mobile terminal, and the through-hole communicates with the front cavity sound outlet channel.

Further, the receiver and the through-hole are provided on a same side of the center line.

Further, a slide groove is provided inside the mobile terminal, the slide groove communicates with the through-hole, a slider capable of sliding is disposed in the slide groove, and the slider slides between a first position and a second position of the slide groove; and

in a case that the slider is located in the first position, the slider closes the through-hole, and in a case that the slider is located in the second position, the slider opens the through-hole.

Further, the receiver and the slide groove are provided on a same side of the center line.

Further, the slider in the slide groove is capable of freely sliding under gravitational force.

Further, a limiting member for fixing the slider is disposed in the first position or the second position of the slide groove.

Further, a drive mechanism is disposed inside the mobile terminal, where the drive mechanism is connected to the slider, and the drive mechanism is configured to drive the slider to slide between the first position and the second position.

Further, an air filter is disposed in the through-hole.

### BRIEF DESCRIPTION OF DRAWINGS

FIG. 1 is a first structural diagram of a mobile terminal according to an embodiment of the present disclosure;

FIG. 2 is a second structural diagram of a mobile terminal according to an embodiment of the present disclosure;

FIG. 3 is a third structural diagram of a mobile terminal according to an embodiment of the present disclosure;

FIG. 4a is a first graph contrasting curves of distortion according to an embodiment of the present disclosure;

FIG. 4b is a second graph contrasting curves of distortion according to an embodiment of the present disclosure;

FIG. 5 is a fourth structural diagram of a mobile terminal according to an embodiment of the present disclosure;

FIG. 6 is a fifth structural diagram of a mobile terminal according to an embodiment of the present disclosure; and

FIG. 7 is a sixth structural diagram of a mobile terminal according to an embodiment of the present disclosure.

### DESCRIPTION OF EMBODIMENTS

The following clearly describes the technical solutions in the embodiments of the present disclosure with reference to the accompanying drawings in the embodiments of the present disclosure. Apparently, the described embodiments are merely some rather than all of the embodiments of the present disclosure. All other embodiments obtained by persons of ordinary skill in the art based on the embodiments of the present disclosure shall fall within the protection scope of the present disclosure.

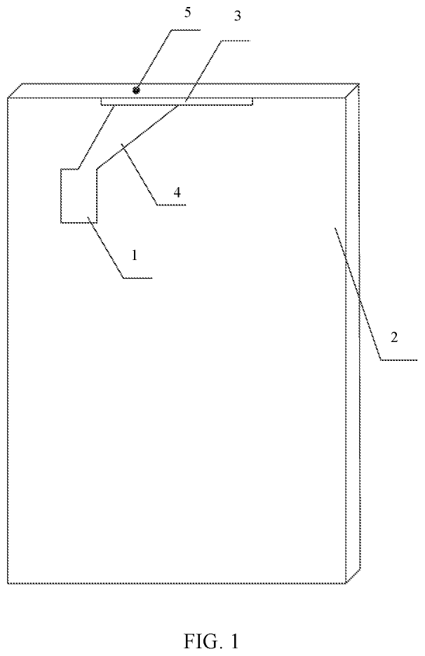

Referring to FIG. 1, FIG. 1 is a first structural diagram of a mobile terminal according to an embodiment of the present disclosure. As shown in FIG. 1, this embodiment provides the mobile terminal. The mobile terminal includes:

a receiver 1, disposed on one side of a center line of the mobile terminal, where a sound outlet hole 3 is provided in a display screen 2 of the mobile terminal, a front cavity sound outlet channel 4 of the receiver 1 is provided inside the mobile terminal, and the front cavity sound outlet channel 4 communicates with the sound outlet hole 3; and a through-hole 5 is provided at the top of the mobile terminal, and the through-hole 5 communicates with the front cavity sound outlet channel 4.

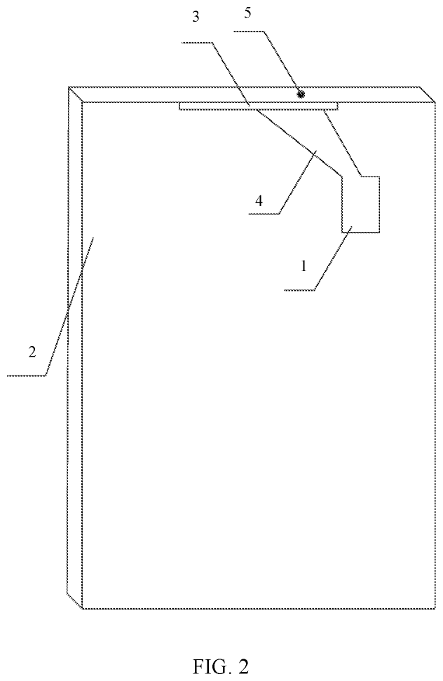

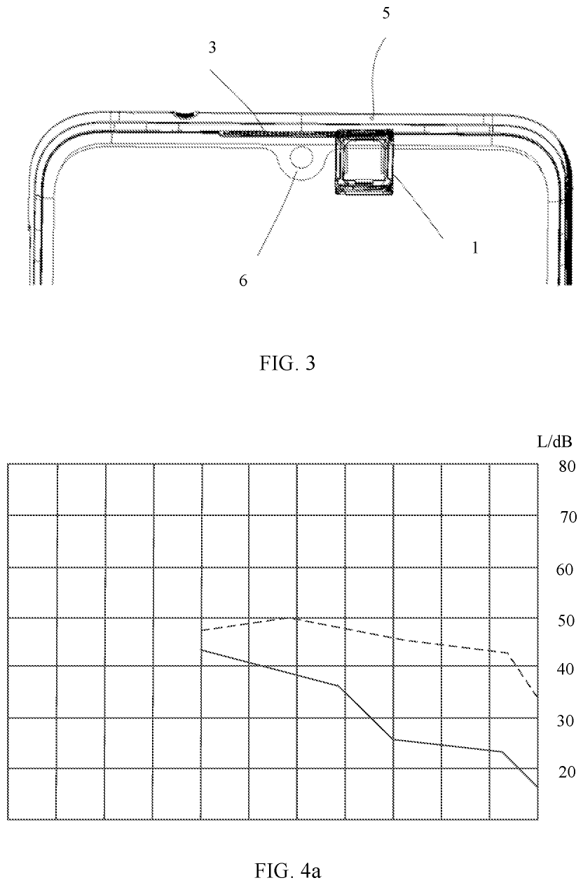

Specifically, the sound outlet hole 3 may be a narrow slit or a tiny slit. The display screen 2 of the mobile terminal is a plane on which a display screen is located. The receiver 1 is disposed at a position in the mobile terminal close to the top. The center line of the mobile terminal may be construed as a center line of the display screen 2. As shown in FIG. 1, the center line of the display screen is a center line in a longitudinal direction of the display screen. As shown in FIG. 1 and FIG. 2, FIG. 1 shows a receiver 1 that is disposed leftward from the middle, and FIG. 2 shows a receiver 1 that is disposed rightward from the middle. That the receiver 1 is disposed on one side of the center line of the mobile terminal may be considered that the receiver 1 is biased. When the receiver 1 is biased, a front camera of the mobile terminal may be disposed in the middle of the display screen 2. As shown in FIG. 3, the reference numeral 6 in the figure represents the front camera.

The top of the mobile terminal may be construed as a top face of the mobile terminal, and the top face is adjacent to the display screen 2. The through-hole 5 is provided at the top of the mobile terminal, the through-hole 5 communicates with the front cavity sound outlet channel 4, and a sound transmitted out through the front cavity sound outlet channel 4 may be transmitted out through the sound outlet hole 3, and may also be transmitted out through the through-hole 5. This can increase the volume of a sound transmitted out of the mobile terminal during speech receiving, and improve speech receiving quality of the mobile terminal.

When a receiver under test is biased, contrast results of sound loudness and distortion of the mobile terminal with and without a through-hole at the top are shown in Table 1.

TABLE 1

| | Receive | | |
|---|---|---|---|
| | loudness | Distortion | Distortion |
| | rating (RLR) | (1020 Hz) | (low frequency) |
| With through-hole | 1.91 | 18.22 | 18.62 |
| Without | −0.17 | 31.98 | 33.67 |
| through-hole | | | |

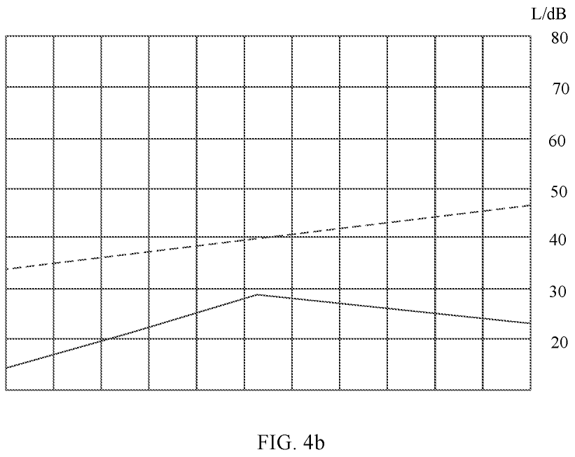

From Table 1, it can be learned that, in a case that a sound outlet hole is blocked, when a through-hole is provided, loudness is improved by 2 db, and distortion is mitigated a lot. In addition, FIG. 4a shows a graph contrasting curves of of distortion at 1020 Hz. A dotted line in FIG. 4a shows a curve of distortion for a mobile terminal provided with a through-hole in the case that a sound outlet hole is partly blocked by an earlobe. A solid line in FIG. 4a shows a curve of distortion for a mobile terminal not provided with a through-hole in the case that a sound outlet hole is partly blocked by an earlobe. FIG. 4b shows a graph contrasting curves of distortion at a low frequency. A dotted line in FIG. 4b shows a curve of distortion for a mobile terminal provided with a through-hole in the case that a sound outlet hole is partly blocked. A solid line in FIG. 4b shows a curve of distortion for a mobile terminal not provided with a through-hole in the case that a sound outlet hole is partly blocked by an earlobe. From FIG. 4a and FIG. 4b, it can be learned that, when the mobile terminal is provided with a through-hole, distortion of sound is mitigated a lot.

Optionally, the receiver 1 and the through-hole 5 are provided on a same side of the center line. That is, in a case that the receiver 1 is located on a first side of the center line, the through-hole 5 is also located on the first side of the center line. The first side may be a left side or a right side. The mobile terminal includes a left frame and a right frame. The display screen is disposed between the left frame and the right frame. That the receiver 1 is located on the first side of the center line may be construed as that the receiver 1 is close to the left frame, or the receiver 1 is close to the right frame. When the receiver 1 is close to the left frame, the through-hole 5 is also close to the left frame. When the receiver 1 is close to the right frame, the through-hole 5 is also close to the right frame.

When the receiver 1 and the through-hole 5 are provided on the same side of the center line (the left side or the right side of the center line), a sound made by the receiver 1 is transmitted out through the through-hole 5 for a relatively short distance. This can reduce an adverse effect of a transmission distance on the volume and tone quality and resolve the problem of low volume and poor tone quality caused by a far transmission distance. The size and position of the through-hole may be provided as appropriate to an actual situation. However, the through-hole needs to be provided near the receiver, so as to avoid decline of sound performance due to increase of a sound transmitting length.

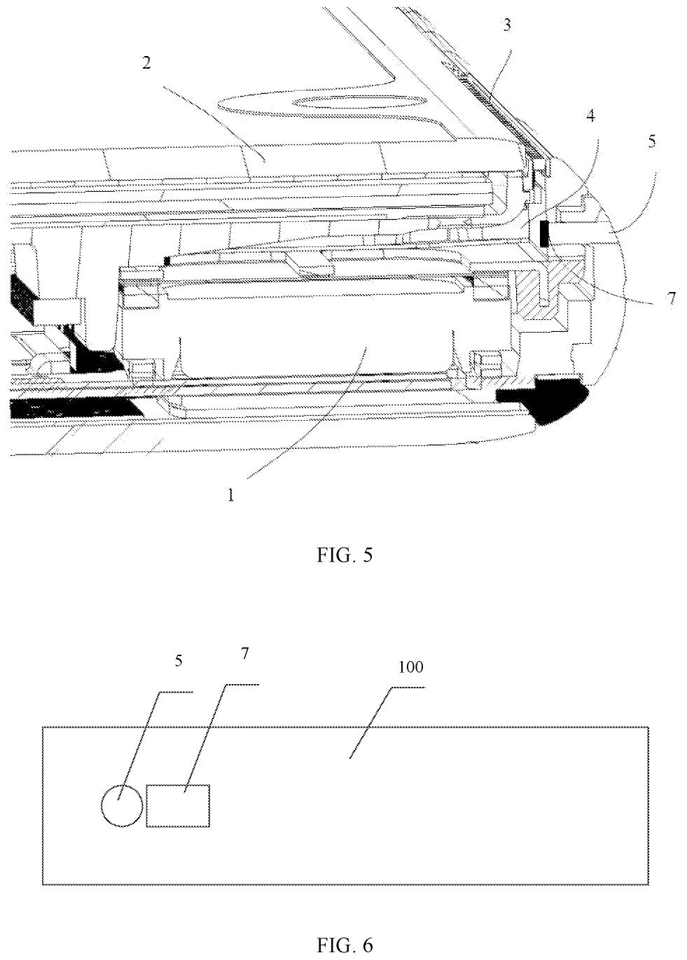

Optionally, as shown in FIG. 5, a slide groove is provided inside the mobile terminal, the slide groove communicates with the through-hole 5, a slider 7 capable of sliding is disposed in the slide groove, and the slider 7 slides between a first position and a second position of the slide groove; and in a case that the slider 7 is located in the first position, the slider 7 closes the through-hole 5, and in a case that the slider 7 is located in the second position, the slider 7 opens the through-hole 5.

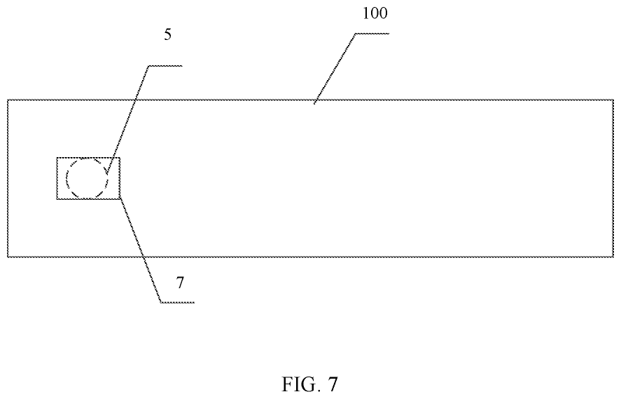

Specifically, when the slider 7 is in the first position, the slider 7 closes the through-hole 5. In this case, the through-hole 5 does not communicate with the front cavity sound outlet channel 4, and a sound made by the receiver 1 cannot be transmitted out through the through-hole 5. When the slider 7 is in the second position, the slider 7 opens the through-hole 5. In this case, the through-hole 5 communicates with the front cavity sound outlet channel 4, and a sound made by the receiver 1 can be transmitted out through the through-hole 5. FIG. 6 and FIG. 7 show sectional views of a mobile terminal. The reference numeral 100 in the figures represents a screen of the mobile terminal. FIG. 6 shows a positional relationship between the slider 7 and the through-hole 5 when the slider 7 is in the second position. FIG. 7 shows a positional relationship between the slider 7 and the through-hole 5 when the slider 7 is in the first position. The slider 7 may match the through-hole 5 in shape. For example, if a cross section of the through-hole 5 is circular, the slider 7 may also be circular; and if the cross section of the through-hole 5 is rectangular, the slider 7 may also be rectangular. In size, the slider 7 is slightly larger than the cross section of the through-hole 5. In this way, when the slider 7 is in the first position, it can be effectively ensured that the slider 7 can block the through-hole 5.

When the slider 7 is in the first position, the slider 7 closes the through-hole 5, and a sound made by the receiver 1 cannot be transmitted out through the through-hole 5. This may prevent sound leakage and protect user privacy. When the slider 7 is in the second position, the slider 7 opens the through-hole 5, and a sound made by the receiver 1 is transmitted out through the through-hole 5. This can increase the volume of a sound transmitted out of the mobile terminal during speech receiving, and improve a speech receiving quality of the mobile terminal. Certainly, the slider 7 may alternatively be designed to close the through-hole 5 in the first position and fully open the through-hole 5 (that is, not block the through-hole 5 at all) in the second position, and the slider 7, at a position between the first position and the second position, partially blocks the through-hole 5. In addition, an air filter is provided in the through-hole 5, so as to prevent dust from falling into the through-hole 5 to block the through-hole 5 and affect sound transmission.

The receiver 1 and the slide groove are provided on a same side of the center line. The receiver 1 and the through-hole 5 are provided on the same side of the center line. This may reduce a length of the slide groove communicating with the through-hole, reducing costs of manufacturing the slide groove and reducing a space occupied by the slide groove.

That the slider 7 slides in the slide groove may include two implementations. In a first implementation, the slider 7 in the slide groove is capable of freely sliding under gravitational force. In a second implementation, a drive mechanism is disposed inside the mobile terminal, where the drive mechanism is connected to the slider 7, and the drive mechanism is configured to drive the slider 7 to slide between the first position and the second position.

In the first implementation, the slider 7 in the slide groove freely slides under gravitational force. In this way, the slider 7 freely slides under gravitational force, to close the through-hole 5, so as to prevent sound leakage and protect user privacy; or to open the through-hole 5, so as to increase the volume of a sound transmitted out of the mobile terminal during speech receiving, and improve a speech receiving quality of the mobile terminal.

To avoid that the slider 7 slides under gravitational force along with an angle change of the mobile terminal when no speech is being received, a limiting member for fixing the slider 7 may be disposed in the first position or the second position of the slide groove, so as to prevent the slider 7 from sliding in the slide groove when no speech is being received. When the mobile terminal is receiving a speech, the limiting member relieves the fixture on the slider 7, and the slider 7 is capable of freely sliding in the slide groove under gravitational force, to close the through-hole 5 or open the through-hole 5.

In the second implementation, a drive mechanism is disposed inside the mobile terminal, where the drive mechanism is connected to the slider 7, and the drive mechanism is configured to drive the slider 7 to slide between the first position and the second position. The drive mechanism may be connected to a control chip of the mobile terminal. The control chip controls, based on an input operation of a user, the drive mechanism to drive the slider 7 to slide. In this case, the user may set a position of the slider 7 based on an actual demand, to selectively open the through-hole 5 or close the through-hole 5.

The receiver 1 being disposed leftward from the middle is used as an example. The receiver 1 is disposed leftward. The slide groove is provided on the left side of the through-hole 5. When a user is receiving a speech with the left ear, the left top of the mobile terminal is located below the right top of the mobile terminal, the slider 7 slides to the second position under gravitational force, or the slider 7 is driven by the drive mechanism to slide to the second position. In this case, the through-hole 5 communicates with the front cavity sound outlet channel 4, and a sound made by the receiver 1 may be transmitted out through the through-hole 5. Because the receiver 1 is disposed leftward, when the user is receiving a speech with the left ear, a first part of the sound outlet hole 3 (the first part is a part of the sound outlet hole 3 close to the front cavity sound outlet channel 4) is blocked, and a sound is transmitted out only through a second part of the sound outlet hole 3 (the second part is a part of the sound outlet hole 3 far from the front cavity sound outlet channel 4), which is low in volume and poor in tone quality. However, based on the implementations of this embodiment, a sound made by the receiver 1 may be transmitted out through the through-hole 5. This can increase the volume of a sound transmitted out of the mobile terminal during speech receiving, and improve a speech receiving quality of the mobile terminal, thereby resolving the problem of low volume and poor tone quality of the mobile terminal.

The receiver 1 is disposed leftward. The slide groove is provided on the left side of the through-hole 5. When the user is receiving a speech with the right ear, the right top of the mobile terminal is located below the left top of the mobile terminal, the slider 7 slides to the first position under gravitational force, or the slider 7 is driven by the drive mechanism to slide to the first position. In this case, the through-hole 5 does not communicate with the front cavity sound outlet channel 4, and a sound made by the receiver 1 cannot be transmitted out through the through-hole 5. Because the receiver 1 is disposed leftward, when the user is receiving a speech with the right ear, a first part of the sound outlet hole 3 (the first part is a part of the sound outlet hole 3 close to the front cavity sound outlet channel 4) is not blocked, and a sound transmitted out through the sound outlet hole 3 is not affected. In this case, a sound transmitted out of the mobile terminal is normal, user experience is not affected, and there is no need to use the through-hole 5 to assist in transmitting a sound. In this case, the slider 7 closes the through-hole 5, and a sound made by the receiver 1 may not be transmitted out through the through-hole 5. This can effectively prevent sound leakage and protect user privacy.

The mobile terminal in the foregoing embodiment may be a mobile phone, a tablet computer, a laptop computer, a personal digital assistant (PDA), a mobile internet device (MID), a wearable device, or the like.

The foregoing descriptions are only specific implementations of the present disclosure, but are not intended to limit the protection scope of the present disclosure. Any variation or replacement readily figured out by persons skilled in the art within the technical scope disclosed in the present disclosure shall fall within the protection scope of the present disclosure. Therefore, the protection scope of the present disclosure shall be subject to the protection scope of the claims.

What is claimed is:

1. A mobile terminal, comprising:
a receiver, disposed on one side of a center line of the mobile terminal, wherein
a sound outlet hole is provided in a display screen of the mobile terminal, a front cavity sound outlet channel of the receiver is provided inside the mobile terminal, and the front cavity sound outlet channel communicates with the sound outlet hole; and
a through-hole is provided at the top of the mobile terminal, and the through-hole communicates with the front cavity sound outlet channel.

2. The mobile terminal according to claim 1, wherein the receiver and the through-hole are provided on a same side of the center line.

3. The mobile terminal according to claim 1, wherein a slide groove is provided inside the mobile terminal, the slide groove communicates with the through-hole, a slider capable of sliding is disposed in the slide groove, and the slider slides between a first position and a second position of the slide groove; and
in a case that the slider is located in the first position, the slider closes the through-hole, and in a case that the slider is located in the second position, the slider opens the through-hole.

4. The mobile terminal according to claim 3, wherein the receiver and the slide groove are provided on a same side of the center line.

5. The mobile terminal according to claim 3, wherein the slider in the slide groove is capable of freely sliding under gravitational force.

6. The mobile terminal according to claim 5, wherein a limiting member for fixing the slider is disposed in the first position or the second position of the slide groove.

7. The mobile terminal according to claim 3, wherein a drive mechanism is disposed inside the mobile terminal, wherein the drive mechanism is connected to the slider, and the drive mechanism is configured to drive the slider to slide between the first position and the second position.

8. The mobile terminal according to claim 1, wherein an air filter is disposed in the through-hole.
